(19) United States
(12) Patent Application Publication
(10) Pub. No.: US 2015/0100413 A1
(43) Pub. Date: Apr. 9, 2015

(54) GENERATING AND USING ENTITY SELECTION CRITERIA

(71) Applicant: Google Inc., Mountain View, CA (US)

(72) Inventors: Alexander Collins, Denver, CO (US); Yue Kwen Justin Yip, Sunnyvale, CA (US)

(73) Assignee: Google Inc., Mountain View, CA (US)

(21) Appl. No.: 14/049,761

(22) Filed: Oct. 9, 2013

(51) Int. Cl. G06Q 30/02

(52) U.S. Cl. CPC G06Q 30/0243; G06Q 30/0256
USPC 705/14.42

(57) ABSTRACT

Methods, systems, and apparatus include computer programs encoded on a computer-readable storage medium, including a method for generating selection criteria. Data indicative of a landing page and data indicative of one or more types of business are received. One or more collections in a plurality of collections are identified, the identified collections being based at least in part on the types of business and including one or more entities. A first group of one or more entities is selected from the one or more identified collections. A second group of one or more entities is identified from the landing page. The first group of entities is compared with the second group of entities. Based on the comparing, selection criteria is generated for one or more content items, wherein the selection criteria is used to identify one or more particular content items in response to receiving a request for information.

### BACKGROUND

This specification relates to information presentation.

The Internet provides access to a wide variety of resources. For example, video and/or audio files, as well as web pages for particular subjects or particular news articles, are accessible over the Internet. Access to these resources presents opportunities for other content (e.g., advertisements) to be provided with the resources. For example, a web page can include slots in which content can be presented. These slots can be defined in the web page or defined for presentation with a web page, for example, along with search results.

Slots can be allocated to content sponsors through a reservation system or an auction. For example, content sponsors can provide bids specifying amounts that the sponsors are respectively willing to pay for presentation of their content. In turn, a reservation can be made or an auction can be performed, and the slots can be allocated to sponsors according, among other things, to their bids and/or the relevance of the sponsored content to content presented on a page hosting the slot or a request that is received for the sponsored content.

### SUMMARY

In general, one innovative aspect of the subject matter described in this specification can be implemented in methods that include a computer-implemented method for generating selection criteria. The method includes receiving data indicative of a landing page and data indicative of one or more types of business. The method further includes identifying one or more collections in a plurality of collections, the identified collections being based at least in part on the types of business and including one or more entities. The method further includes selecting a first group of one or more entities from the one or more identified collections. The method further includes identifying, from the landing page, a second group of one or more entities. The method further includes comparing the first group of entities with the second group of entities. The method further includes generating, based on the comparing, selection criteria for one or more content items, wherein the selection criteria is used to identify one or more particular content items in response to receiving a request for information.

These and other implementations can each optionally include one or more of the following features. Receiving can further include receiving data indicative of a business name, wherein the data indicative of a landing page, the data indicative of one or more types of business, and the data indicative of the business name are received from a content sponsor. Identifying one or more collections can further include determining, based on the type of business, a quality score for one or more collections in the plurality of collections, and selecting, as the identified collections, one or more collections in the plurality of collections that have a higher quality score relative to other collections in the plurality of collections. Determining the quality score can further include accessing a mapping between a type of business and a collection for which a quality score is predetermined and using the predetermined quality score as the determined quality score for a particular collection based on the accessing. Selecting the first group of one or more entities from one or more identified collections can further include performing at least one of a union operation and an intersection operation on the one or more identified collections and selecting the first group of one or more entities based on the performing. Identifying, from the landing page, the second group of one or more entities can further include identifying one or more entities from the landing page, the one or more identified entities being associated with a confidence score and an associated topicality score and selecting, as the second group of one or more entities, at least one or more of the one or more identified entities based on respective confidence score and topicality score. Comparing the first group of entities with the second group of entities can include performing an intersection operation on the first collection and the second collection to determine one or more entities that are included in both the first collection and the second collection, and generating selection criteria can include generating selection criteria based at least in part on the intersection. Generating the selection criteria can include generating a campaign that, based on the comparing, that includes selection criteria including one or more entities that are included in both the first collection and the second collection and associating the campaign with the one or more content items.

In general, another innovative aspect of the subject matter described in this specification can be implemented in computer program products that include a computer program product tangibly embodied in a non-transitive computer-readable medium and comprising instructions. The instructions, when executed by one or more processors, cause the processor to: receive data indicative of a landing page and data indicative of one or more types of business; identify one or more collections in a plurality of collections, the identified collections being based at least in part on the types of business and including one or more entities; select a first group of one or more entities from the one or more identified collections; identify, from the landing page, a second group of one or more entities; compare the first group of entities with the second group of entities; and generate, based on the comparing, selection criteria for one or more content items, wherein the selection criteria is used to identify one or more particular content items in response to receiving a request for information.

These and other implementations can each optionally include one or more of the following features. Receiving can further include receiving data indicative of a business name, wherein the data indicative of a landing page, the data indicative of one or more types of business, and the data indicative of the business name are received from a content sponsor. Identifying one or more collections can further include determining, based on the type of business, a quality score for one or more collections in the plurality of collections and selecting, as the identified collections, one or more collections in the plurality of collections that have a higher quality score relative to other collections in the plurality of collections. Determining the quality score can further include accessing a mapping between a type of business and a collection for which a quality score is predetermined and using the predetermined quality score as the determined quality score for a particular collection based on the accessing. Selecting the first group of one or more entities from the one or more identified collections can further include performing at least one of a union operation and an intersection operation on the one or more identified collections and selecting the first group of one or more entities based on the performing. Identifying, from the landing page, the second group of one or more entities can further include identifying one or more entities from the landing page, the one or more identified entities being associated with a confidence score and an associated topicality score and selecting, as the second group of one or more entities, at least one or more of the one or more identified entities based on respective confidence score and topicality score. Comparing the first group of entities with the second group of entities can include: performing an intersection operation on the first collection and the second collection to determine one or more entities that are included in both the first collection and the second collection, and generating selection criteria can include generating selection criteria based at least in part on the intersection. Generating the selection criteria can include generating a campaign that, based on the comparing, includes selection criteria including one or more entities that are included in both the first collection and the second collection and associating the campaign with the one or more content items.

In general, another innovative aspect of the subject matter described in this specification can be implemented in systems, including a system that includes a collection identifier for identifying one or more collections that may include one or more relevant entities, an annotator for parsing and extracting terms from text documents, an entity selection engine for selecting one or more entities that are included in the one or more identified collections, and an entity comparison engine for comparing entities in a first group of entities and other groups of entities.

These and other implementations can each optionally include one or more of the following features. Identifying one or more collections can further include determining, based on the type of business, a quality score for one or more collections in the plurality of collections and selecting, as the identified collections, one or more collections in the plurality of collections that have a higher quality score relative to other collections in the plurality of collections. Determining the quality score can further include accessing a mapping between a type of business and a collection for which a quality score is predetermined and using the predetermined quality score as the determined quality score for a particular collection based on the accessing. Comparing the first group of entities with the second group of entities can include performing an intersection operation on the first collection and the second collection to determine one or more entities that are included in both the first collection and the second collection, and generating selection criteria can include generating selection criteria based at least in part on the intersection.

Particular implementations may realize none, one or more of the following advantages. Content can be selected for presentation to a user without relying on purchasing or web interaction history for the user. Augmented or recommended selection criteria for a campaign can be generated. Search query disambiguation can be improved based at least in part on using entities to either augment/improve or otherwise provide context to a user search so as to enable selection of additional relevant content for presentation to a user.

The details of one or more implementations of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram of an example environment for providing content to a user.

FIG. 2 is a block diagram of an example system for providing content to a user.

FIG. 3 is a flowchart of an example process for determining selection criteria.

FIG. 4 is a block diagram of computing devices that may be used to implement the systems and methods described in this document, as either a client or as a server or plurality of servers.

Like reference numbers and designations in the various drawings indicate like elements.

### DETAILED DESCRIPTION

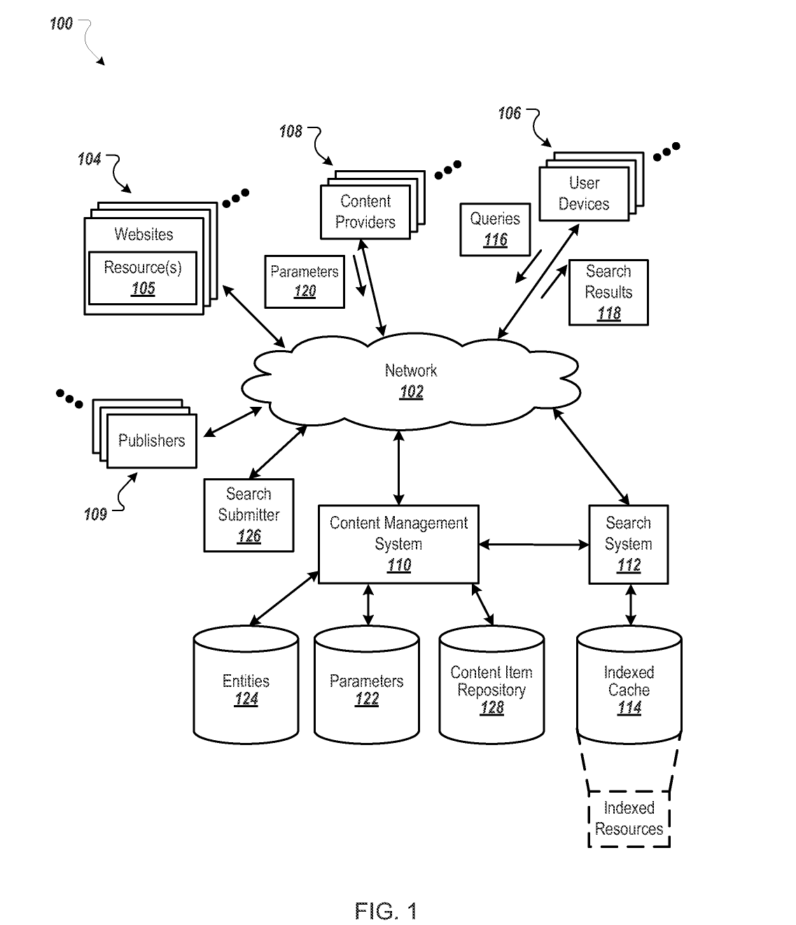

In general, the subject matter of this disclosure relates to determining selection criteria for a content item, such as a content item that is stored in inventory and delivered in accordance with the selection criteria based on received requests. In one example method, selection criteria are determined based on comparing one or more entities that are associated with a first source with one or more entities that are associated with a second different source. A source can be selected from the group comprising a landing page or other content associated with a content sponsor or content sponsor's campaign, or a collection of entities that are derived from one or more keywords or other metadata. For example, one method includes identifying a first group of entities from a first source of entities and a second group of entities from second source of entities. In one specific example, a first group of entities can be identified in a collection of entities. The collection of entities can be derived from terms of a query or keywords that are proposed for a campaign. A second group of entities can be identified in a landing page or other electronic document maintained by a content provider, such as an advertiser, associated with a campaign. The first group of entities can be compared to the second group of entities and entities that appear both in the first group of entities and the second group of entities can be used to generate selection criteria for the campaign. The selection criteria can be suggested to a content sponsor or automatically added to a campaign. The campaign can be associated with relevant content items to provide in response to a request that satisfies the selection criteria. As a result, when a request is received that substantially satisfies the selection criteria (as modified based on the compared entities), one or more of the associated content items can be provided (e.g., such as in addition to search results that are responsive to the request). Various techniques for identifying selection criteria for use in a campaign are described in association with FIG. 1.

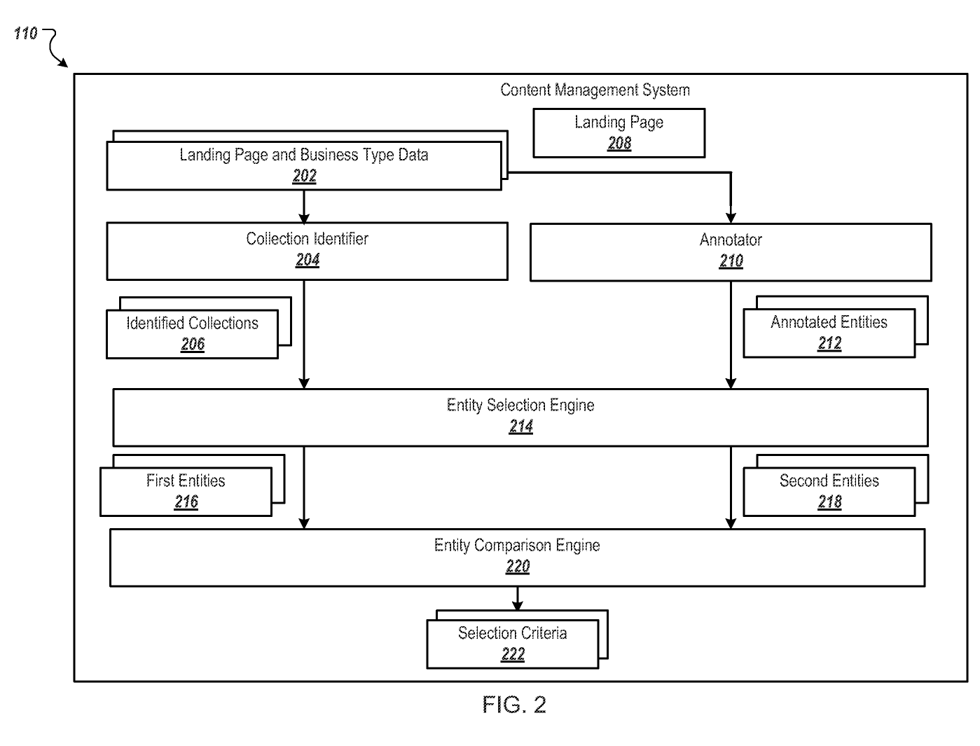

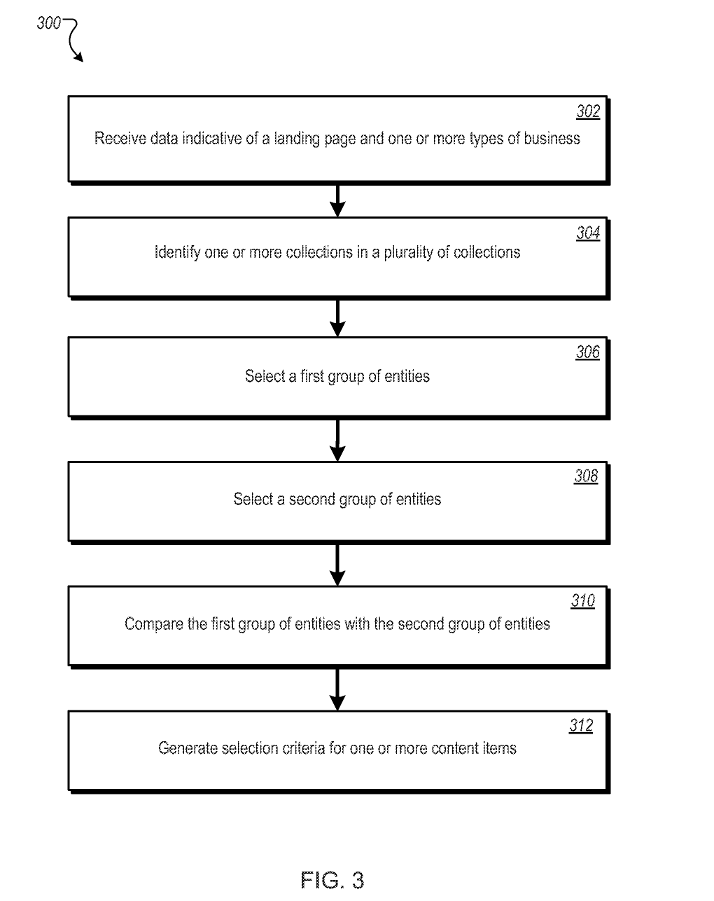

In general, an entity can be a person, place, product, service, vertical concept, or abstract idea. In general, a collection is a group of entities that share a common characteristic. For example, a “best movies collection of 2000” may include a list of films from the year 2000, each representing an entity. Different collections can include the same entities. For example, a collection for football players—or for hall of fame football players—includes the entity “Jim Brown” while a collection for movie stars can also include the entity “Jim Brown.” Multiple collections may be identified and evaluated to determine selection criteria for a campaign. For example, certain collections may be more indicative of a commercial activity than other collections and those collections may be more useful in determining selection criteria (e.g., because entities in those collections may be more likely to have associated content items). Additional details for determining selection criteria are discussed below in association with FIGS. 2 and 3.

When a request or query is received, the request may include or be associated with metadata (that define characteristics of a given slot/impression or keywords) that defines conditions, requirements, or other criteria that should be considered/satisfied in order to ensure a highly relevant content item is returned responsive to the request or query. The metadata associated with the request or query can then be compared to selection criteria that are included in inventory for content that is to be distributed by a content delivery system. When keywords are provided as part of a request (or used as selection criteria), the keywords themselves may be ambiguous making a determination as to whether content items associated with a specific set of selection criteria should be included in a response to the request or query difficult. Accordingly, in some implementations, identifying entities associated with these keywords may be helpful to better satisfy a given request/query.

Even where entities are used, some ambiguity may still exist because the context in which a particular keyword is used may make it difficult to determine which entity should be selected for the particular keyword. For example the keyword Jaguar, may refer to a mammal, an automobile, or an insect, where each of these are themselves different entities. In order to determine a context or resolve ambiguity in these situations, determining a likely entity from among the available entities can be performed using an entity matching processes, e.g. by determining that an entity from a relevant collection matches an entity identified in an electronic document associated with the content provider.

Methods and systems proposed can be used to determine relevant entities to associate with a particular adgroup or campaign or to resolve ambiguity when evaluating received keywords that are used to select which content to deliver. In the examples provided below, processes are described for determining a group of entities from which to generate selection criteria.

FIG. 1 is a block diagram of an example environment 100 for providing content to a user. The example environment 100 includes a network 102 such as a local area network (LAN), wide area network (WAN), the Internet, or a combination thereof. The network 102 connects websites 104, user devices 106, content providers 108 (e.g., a content provider 108a and a content provider 108b), publishers 109, and a content management system 110. The example environment 100 may include many thousands of websites 104, user devices 106, content providers 108, and publishers 109.

A website 104 includes one or more resources 105 associated with a domain name and hosted by one or more servers. An example website 104 is a collection of webpages formatted in hypertext markup language (HTML) that can contain text, images, multimedia content, and programming elements, e.g., scripts. Each website 104 is maintained by, for example, a publisher 109, e.g., an entity that controls, manages and/or owns the website 104. Used herein, the term “landing page” can be used to describe a particular webpage whose link or reference can be included as part of content delivered responsive to a received request. The landing page can be one of the websites 104 that can be presented to a user when the user selects a link returned by a search system 112. That is, a landing page can be a webpage that provides information that is relevant to the visitor, where the relevance is determined by the search system 112.

A resource 105 is any data that can be provided over the network 102. A resource 105 is identified by a resource address that is associated with the resource 105. Resources 105 include HTML pages, word processing documents, and portable document format (PDF) documents, images, video, and feed sources, to name only a few examples. The resources 105 can include content, e.g., words, phrases, images and sounds that may include embedded information (such as meta-information in hyperlinks) and/or embedded instructions (such as scripts).

To facilitate searching of resources 105, the environment 100 can include a search system 112 that identifies the resources 105, for example, by crawling and indexing the resources 105 provided by the publishers 109 on the websites 104. In some implementations, data about the resources 105 can be indexed based on the resource 105 to which the data corresponds. The indexed and, optionally, cached copies of the resources 105 can be stored in an indexed cache 114.

A user device 106 is an electronic device that is under control of a user and is capable of requesting and receiving resources 105 over the network 102. Example user devices 106 include personal computers, mobile communication devices, tablet devices, and other devices that can send and receive data over the network 102. A user device 106 typically includes a user application, such as a web browser, to facilitate the sending and receiving of data over the network 102 and the presentation of content to a user.

A user device 106 can request resources 105 from a website 104. In turn, data representing the resource 105 can be provided to the user device 106 for presentation by the user device 106. User devices 106 can also submit search queries 116 to the search system 112 over the network 102. In response to a search query 116, the search system 112 can, for example, access the indexed cache 114 to identify resources 105 that are relevant to the search query 116. The search system 112 identifies the resources 105 in the form of search results 118 and returns the search results 118 to the user devices 106 in search results pages. A search result 118 is data generated by the search system 112 that identifies a resource 105 that is responsive to a particular search query 116, and includes a link to the resource 105. An example search result 118 can include a web page title, a snippet of text or a portion of an image extracted from the web page, and the URL (Unified Resource Location) of the web page.

The data representing the resource 105 or the search results 118 can also include data specifying a portion of the resource 105 or search results 118 or a portion of a user display (e.g., a presentation location of a pop-up window or in a slot of a web page) in which other content (e.g., advertisements) can be presented. These specified portions of the resource or user display are referred to as slots or impressions. An example slot is an advertisement slot.

In some implementations, slots on search results pages or other webpages can include content slots for content items that have been provided as part of a reservation process. In a reservation process, a publisher and a content item sponsor enter into an agreement where the publisher agrees to publish a given content item in accordance with a schedule (e.g., provide 1000 impressions by date X) or other publication criteria. In some implementations, content items that are selected to fill the requests for content slots can be selected based, at least in part, on priorities associated with a reservation process (e.g., based on urgency to fulfill a reservation).

When a resource 105 or search results 118 are requested by a user device 106, the content management system 110 may receive a request for content to be provided with the resource 105 or search results 118. The request for content can include characteristics of one or more slots or impressions that are defined for the requested resource 105 or search results 118. For example, a reference (e.g., URL) to the resource 105 or search results 118 for which the slot is defined, a size of the slot, and/or media types that are available for presentation in the slot can be provided to the content management system 110. Similarly, keywords associated with a requested resource (“resource keywords”) or a search query 116 for which search results 118 are requested can also be provided to the content management system 110 to facilitate identification of content that is relevant to the resource or search query 116. A request for a resource 105 or a search query 116 can also include an identifier, such as a cookie, identifying the requesting user device 106 (e.g., in instances in which the user consents in advance to the use of such an identifier).

Based, for example, on data included in the request for content, the content management system 110 can select content items that are eligible to be provided in response to the request, such as content items having characteristics (e.g., selection criteria) matching the characteristics of a given slot. As another example, content items having selection criteria (e.g., keywords) that match the resource keywords or the search query 116 may be selected as eligible content items by the content management system 110. One or more selected content items can be provided to the user device 106 in association with providing an associated resource 105 or search results 118.

In some implementations, the content management system 110 can select content items based at least in part on results of an auction. For example, content providers 108 can provide bids specifying amounts that the content providers 108 are respectively willing to pay for presentation of their content items. In turn, an auction can be performed and the slots can be allocated to content providers 108 according, among other things, to their bids and/or the relevance of a content item to content presented on a page hosting the slot or a request that is received for the content item. For example, when a slot is being allocated in an auction, the slot can be allocated to the content provider 108 that provided the highest bid or a highest auction score (e.g., a score that is computed as a function of a bid and/or a quality measure). When multiple slots are allocated in a single auction, the slots can be allocated to a set of bidders that provided the highest bids or have the highest auction scores.

In some implementations, some content providers 108 prefer that the number of impressions allocated to their content and the price paid for the number of impressions be more predictable than the predictability provided by an auction. For example, a content provider 108 can increase the likelihood that its content receives a desired or specified number of impressions, for example, by entering into an agreement with a publisher 109, where the agreement requires the publisher 109 to provide at least a threshold number of impressions (e.g., 1,000 impressions) for a particular content item provided by the content provider 108 over a specified period (e.g., one week). In turn, the content provider 108, publisher 109, or both parties can provide data to the content management system 110 that enables the content management system 110 to facilitate satisfaction of the agreement.

For example, the content provider 108 can upload a content item and authorize the content management system 110 to provide the content item in response to requests for content corresponding to the website 104 of the publisher 109. Similarly, the publisher 109 can provide the content management system 110 with data representing the specified time period as well as the threshold number of impressions that the publisher 109 has agreed to allocate to the content item over the specified time period. Over time, the content management system 110 can select content items based at least in part on a goal of allocating at least a minimum number of impressions to a content item in order to satisfy a delivery goal for the content item during a specified period of time.

A content provider 108 or content sponsor can create a content campaign associated with one or more content items using tools provided by the content management system 110. For example, the content management system 110 can provide one or more account management user interfaces for creating and managing content campaigns. The account management user interfaces can be made available to the content provider 108, for example, either through an online interface provided by the content management system 110 or as an account management software application installed and executed locally at a content provider's client device.

A content provider 108 can, using the account management user interfaces, provide campaign parameters 120 which define the content campaign. The content campaign can be created and activated for the content provider 108 according to the parameters 120 specified by the content provider 108. The campaign parameters 120 can be stored in a parameters data store 122. Campaign parameters 120 can include, for example, a campaign name, a preferred content network for placing content, a budget for the campaign, start and end dates for the campaign, a schedule for content placements, content (e.g., creatives), and selection criteria. Selection criteria, a language, one or more geographical locations or websites, and/or one or more selection terms (e.g., keywords). As another example, a content provider 108 can annotate some or all selection criteria with one or more entities. In general, an entity can be named and can represent, for example, a person (e.g., celebrity, president), place (e.g., national park, city), thing (e.g., ice cream, sweater), or concept (e.g., biology, motherhood)). Other examples of entities include a product, service, organization, vertical, or abstract idea. A group or category of entities can be considered to be itself a single entity (e.g., baseball players). A collection is a grouping of entities that share a common characteristic (e.g., “best movies of 2000” collection, includes a list of entities each associated with a critically acclaimed movie from the year 2000).

In some implementations, annotating selection criteria with one or more entities can result in a better user experience than when a more basic matching of selection criteria to a request keyword is performed. For example, for some selection criteria, a simple match of a selection criteria keyword to a request keyword may not result in an appropriate content item being selected for the request. For example, a request keyword may be the word “firing”, which, if a simple match is performed, may be matched to content items having selection criteria related to “firing a weapon”, “firing an employee”, “firing (e.g. igniting) a fireplace”, etc. The content provider 108, who can be, for example, a human resources consulting firm, can, as part of configuring a campaign, associate, for example, an entity that represents a concept of “firing an employee” to a particular content item, group of content items, or a campaign. That way, the content provider's 108 content (e.g., related to firing employees) won't be presented when a request comes in, for example, for a website that relates to pottery (e.g., where “firing” for this type of entity refers more likely to the process of turning the clay into a finished product).

Similarly, by determining whether one or more entities in a first group of entities matches one or more entities in a second group of entities, a better user experience can result. For example, these techniques can be applied to identify more appropriate content items as being responsive to a particular request, such as search query 116. In a particular example, a first collection of content items may be responsive to the search query 116 and are related to a first commercial entity named “Jaguar” (and being associated with a first entity identifier). This first collection of content items may be substantially different to other collections of content items that may also be responsive to the search query 116 but are related to one or more other commercial or non-commercial entities named “Jaguar” (and being associated with a second entity identifier). If, for example, the search query 116 uses the term Jaguar, the non-commercial entity named “Jaguar” may be selected when the commercial entity named “Jaguar” was intended by the provider of the search query 116. This may produce less than desirable results.

In the proposed examples, the content management system 110 can use selection criteria and annotated entities when evaluating received requests for content. For example, a search query 116 can be received that includes an entity designation. For example, a user can be provided with and can select one or more entity suggestions based on an entered search query 116. As another example, an entity can be inferred from a user-provided search query 116. As yet another example, a search query 116 can be received by a computer system, such as a search submitter system 126, where the received search query 116 is annotated with one or more entity designations. The search submitter 126 can, for example, submit a search query 116 that is annotated with an entity designation that includes, for example, a detailed information panel that presents relevant structured data about the entity to the user.

The content management system 110 can compare request keywords and a received entity designation to selection criteria and an entity designation associated with a content item. The content management system 110 can determine that a match exists between a content request and a content item, such as by determining that an entity designation associated with the content request matches an entity designation associated with the content item. The content management system 110 can select the content item for the content request and can provide the selected content item to the requesting user device 106. Other examples are possible, such as described in more detail below.

In some implementations, information pertaining to one or more content items may be stored in a content items repository 128. The content items repository 128 may be any data store that is suitable for storing relationships between one or more contents items, one or more keywords, one or more landing pages, and combinations of these. For example, the content items repository 128 can be a relational database. In a particular example, a relational database may store relationships between content items (e.g., advertisements) for a particular sports car, one or more keywords or keyword phrases that can be used to describe the particular sports car, and a URL for a landing page that shows the particular sports car. In this particular example, the keywords may include the name of the product (e.g., “Sports Car X”), an attribute or characteristic of the product (e.g., “zero to sixty in 2.5 seconds”), a competitor's product (e.g., “Sports Car Y”), and other keywords.

In some implementations, the content item repository can store information that pertains to one or more content items that correspond to a specific area, theme, or product for a particular content sponsor (e.g., such as a car manufacturer). In some implementations, the content sponsor can be a content provider. A content item stored in the content item repository can be associated with one or more campaigns. For example, a particular advertising campaign may have one or more different targets (e.g., such as a demographic group) and one or more adgroups of content items that are directed to at least some of the targets. In a particular example, a car manufacturer may wish to provide content items related to a car's safety to a parental demographic and may wish to provide content items related to a car's performance or physical characteristics to a different demographic based at least in part on keywords or terms that corresponding to entities received in a search query 116. In some implementations, an entry in the content item repository 128 is of the form of an adgroup which may have a particular adgroup id that differentiates one adgroup from another adgroup in the content item repository 128.

For situations in which the systems discussed here collect information about users, or may make use of information about users, the users may be provided with an opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that certain information about the user is removed. For example, a user's identity may be treated so that no identifying information can be determined for the user, or a user's geographic location may be generalized where location information is obtained (such as to a city, ZIP code, or state level), so that a particular location of a user cannot be determined. Thus, the user may have control over how information is collected about the user and used by a content server.

FIG. 2 is a block diagram of an example content management system 110. As described above, the content management system 110 can provide one or more content items in response to requests for content. The content management system 110 may determine/suggest/use selection criteria that can be included in one or more campaigns. As discussed above, a campaign may be associated with one or more content items so that when a request for content satisfies the selection criteria, one or more content items associated with the campaign can be provided. In general, suggested/augmented or otherwise improved selection criteria can be used to increase the accuracy and/or relevance of the one or more content items that are provided in response to the requests for content.

The example content management system 110 is shown with a number of different components. These components enable the content management system 110 to determine selection criteria that can be associated with one or more campaigns. The determined selection criteria can be used when the content management system 110 evaluates a received request. The content management system 110 includes a collection identifier 204, an annotator 210, an entity selection engine 214, and an entity comparison engine 220.

In general, the content management system 110 can receive landing page and business type data 202 from a content provider. For example, when a content provider wishes to generate a campaign, the advertiser may provide a URL to a landing page for which the content provider wishes users to visit. In addition, the content provider may also provide business type data which the content provider believes describes the content provider's business. That is, a content provider can self-identify one or more business types. For example, a car manufacturer may provide a “car dealership” business type, a “luxury goods” business type, or other business types which the content provider believes are relevant in describing their business. The landing page and business type data 202 can also include a business name for the particular content provider, such as “Jaguar,” “Target,” or other business name.

In response to receiving the landing page and business type data 202, the content management system 110 can provide the landing page and business type data 202 to a collection identifier 204. The content management system 110 can also provide the landing page 208 to an annotator 210.

The collection identifier 204 can identify one or more potentially relevant collections that may include one or more relevant entities. For example, the collection identifier can user the landing page and business type data 202 to identify one or more collections that may include entities that are related to the business name, the business type data, the information included on the landing page, and combinations of these.

In some implementations, the collection identifier 204 can include a predefined mapping between one or more aspects of the landing page and business type data 202 and one or more collections that have been determined to include relevant entities. For example, if the business type is for a “furniture store,” the collection identifier may include a mapping that specifies that the collections named “/collection/hyperpedia/en/furniture,” and “collection/entity_signals_r5_f2_v1/verticals4/hom_and_garden/home_furnishings” include relevant entities. That is, use of a mapping may be considered a pseudo-manual process because an operator of the content management system 110 may generate the mapping based on the operator's understanding or personal knowledge of each of the collections in the plurality of collections and entities that are included in each of the collections. In some implementations, the mapping can include a business type and one or more collections that may be relevant to the business type with an associated quality score. For example, a quality score for a particular collection that is higher relative to other quality scores in the mapping may indicate that certain collections are less relevant or less likely to be relevant for the business type.

In some implementations, one or more automated techniques can be used to determine which of the collections may include relevant entities. For example, one or more keywords that have been identified on a particular landing page included in the landing page and business type data 202 can be analyzed and a minimum number of collections that include all of the identified keywords can be selected. As another example of an automated technique, a single collection can be selected that includes a highest percentage of the identified keywords relative to other collections in the plurality. Nevertheless, the automated techniques may also identify collections named “/collection/hyperpedia/en/furniture,” and “collection/entity_signals_r5_f2_v1/verticals4/hom_and_garden/home_furnishings” for the business type of “furniture store.”

Based on any of the above describe techniques, or other techniques, the collection identifier 204 can identify one or more collections 206 in the plurality of collections. The identified collections 206 can be provided to an entity selection engine 214 for further processing.

The entity selection engine 214 can select one or more entities that are included in the one or more identified collections 206. In some implementations, the entity selection engine 214 can perform a combination of intersection and union operations on the identified collections 206 to determine which of the entities in the identified collections 206 should be selected. For example, an intersection operation can select those entities that appear in some threshold number collections in the identified collections. As another example, a union operation can be performed to select all entities that appear in each of the identified collections 206. Other techniques can also be used to select the entities in the identified collections 206.

The entities that are selected from identified collections 206 are grouped into a first group of entities 216. The first group of entities 216 can then be provided to an entity comparison engine 220 that can be used to determine a match between entities in first group of entities 216 and other groups of entities.

While the content management system 110 selects a first group of entities 216 using the collection identifier 204 and the entity selection engine 214, the content management system 110 can also use the annotator 210 to identify annotated entities 212. The annotator 210 can be used to annotate the contents of a received landing page 208. For example, the annotator can use one or more of a parsing, a comparing, or other techniques to determine a match for a particular entity and a particular term identified on the landing page 208. In general, the annotator 210 is configured to determine or otherwise identify whether a term identified on the landing page 208 is referring to an entity. For example, the annotator 210 can use systems and/or techniques that parse and extract terms (e.g., related to entities) from text documents. In some implementations lists of entities can be maintained, such as part of a knowledge graph or other data structure. Using the lists, for example, a term may be located in the knowledge graph, and an entity can be identified based on being associated with the term.

For example a keyword “fast” may not identify a particular entity, while a keyword “Jaguar” may likely be referring to a specific entity. If for example, the annotator 210 determines that a particular term refers to an entity, the term may be associated with one or more designators that indicate the term likely refers to an entity. In some implementations, the designators may include an entity identifier to which the term may refer and a confidence score that specifies a likelihood to which the term refers to the particular entity. For example, because there may be multiple entities that have the name “Jaguar,” such as the car manufacturer, the beetle, the mammal, and so forth, a confidence score can be associated with each of the entities (e.g., for the car manufacturer, the beetle, and the mammal) using other terms or other entities that are identified on the landing page 208 along with a particular entity in question.

For example, if the landing page 208 included the terms “Jaguar” and “dealer,” a confidence score might be greater as it relates to the car manufacturer than for either of the beetle or the mammal. As another example, if the landing page 208 includes the terms “Jaguar” and “zoo” a confidence score might be greatest for the mammal, then the beetle, and then the car manufacturer. In some implementations, only entity identifiers that satisfy a threshold confidence score are designated.

In some implementations, the annotation results 206 can be stored. For example, the annotation results can be stored in the content item repository 128 (FIG. 1) or other types of data stores. In some implementations, the stored annotations can be used in subsequent attempts to determine selection criteria, e.g., by way of an iterative process of identifying entities on other landing pages and determining selection criteria based on both the stored annotations and the identified entities.

The one or more terms that are identified as a corresponding entity by the annotator 210 can be grouped into one or more annotated entities 212. In some implementations, the annotated entities 212 may include or be otherwise associated with a confidence score and/or a topicality score that has been determined by the annotator 210. For example, terms in a particular portion of the landing page, e.g., a header for text of the landing page, may have a higher topicality score than other portions of the landing page, e.g., a legal disclaimer. As another example, a confidence score for a particular term can be determined by identifying surrounding terms and using those surrounding terms to determine how likely a particular term is being used to describe a candidate entity. The annotated entities 212 can be provided to the entity selection engine 214.

The entity selection engine 214 can use the confidence score and/or the topicality score associated with each of the annotated entities 212 to determine which of the annotated entities should be selected. For example, the entity selection engine 214 can select annotated entities 212 that have a confidence score higher than a predetermined threshold value. As another example, the entity selection engine 214 can a select a predetermined number of annotated entities 212 based on identifying annotated entities that have a highest confidence score and/or topicality score relative to other entities in the annotated entities 212.

The entity selection engine 214, can select a second group of entities 218 from the group of annotated entities 212. The second group of entities 218 can be provided to the entity comparison engine 220 that can be used to determine a match between entities in second group of entities 218 and other groups of entities.

The entity comparison engine 220 can compare multiple groups of entities to determine selection criteria for a particular campaign. For example, the entity comparison engine 220 can determine which of the entities are in both the first group of entities 216 and the second group of entities 218. In some implementations, the entity comparison engine 220 can perform an intersection operation on multiple groups of entities to determine which of the entities in the multiple groups of entities should be used as selection criteria 222. The selection criteria can then be used in connection with a generated campaign to deliver more highly relevant content items in addition to search results that are responsive the request, as described elsewhere in this specification.

FIG. 3 is a flowchart of an example process 300 for determining selection criteria. The process 300 can be performed, for example by the content management system 100 and associated components described above with respect to FIGS. 1 and 2. But other systems and components may be configured to perform or assist in the process 300. In general, the process 300 determines selection criteria by comparing multiple groups of entities that are identified using different techniques.

In operation, data indicative of a landing page and one or more types of business is received (302). For example, data indicative of a landing page, e.g., a URL or other link, can be received from a content sponsor. In addition, the content sponsor may provide one or more selections of one or more types of business. In some implementations, the content sponsor may also provide a business name that is associated with the content sponsor.

One or more collections in a plurality of collections is identified (304). In general, the identified collections are based at least in part of the types of business, the business name, and/or the data indicative of a landing page received from a content sponsor. For example, the content management system 110 can access a predefined mapping that maps a combination of a business name and one or more business types to one or more collections that may contain entities relevant to the particular business name and/or one or more business types. In some implementations, and as described elsewhere in this specification, the mapping can include a quality score that specifies a degree to which a particular collection may include entities relevant to the particular business name and/or one or more types of business.

A first group of entities is selected (306). For example, the content management system 110 can select one or more entities using a number of different techniques. In some implementations, the content management system 110 can select one or more entities that appear with a highest frequency relative to other entities in the identified collections. In some implementations, the content management system 110 can perform at least one of a union operation and/or an intersection operation on the one or more identified collections and select one or more entities based on performing the union and/or the intersection operation.

A second group of entities is identified (308). For example, the content management system 110 can identify one or more entities from content associated with a landing page provided by a content sponsor. In some implementations, the content management system 110 can use various parsing, comparing and other techniques to determine which terms on the landing page may be indicative of particular entities. In some implementations, the entities identified from the terms on the landing page may be associated with a confidence score and/or a topicality score. In some implementations, the content management system 110 can select one or more of the entities based on their respective associated confidence score and/or topicality score. For example, the content management system 110 can selected a number of entities based on associated highest confidence scores relative to other confidence scores associated with other entities.

The first group of entities and the second group of entities is compared (310). For example, the content management system 110 can compare the first group of entities with the second group of entities to determine which entities appear in both the first group and the second group. In some implementations, the content management system 100 can use an intersection operation to perform the comparing.

Selection criteria for one or more content items are generated (312). For example, the content management system 110 can generate selection criteria that include one or more entities that appear in both the first group of entities and the second group of entities. In some implementations, the content management system 110 can generate a campaign that includes the selection criteria. In such implementations, the generated campaign can be associated with one or more content items.

While reference is provided above to the selection of one or more entities to be used as selection criteria, the methods and systems described can be used in other ways. For example, the methods can be used as part of an evaluation of selection criteria for an existing (or proposed) campaign, where an output is provided that represents suggestions for additional or different selection criteria (i.e., based on the evaluation of the entities as described above). In some implementations, the methods can be used to automatically generate selection criteria for a campaign with minimal input from a campaign sponsor. In some implementations, the methods can be used to make suggestions to further augment selection criteria for a campaign. These and other uses are possible.

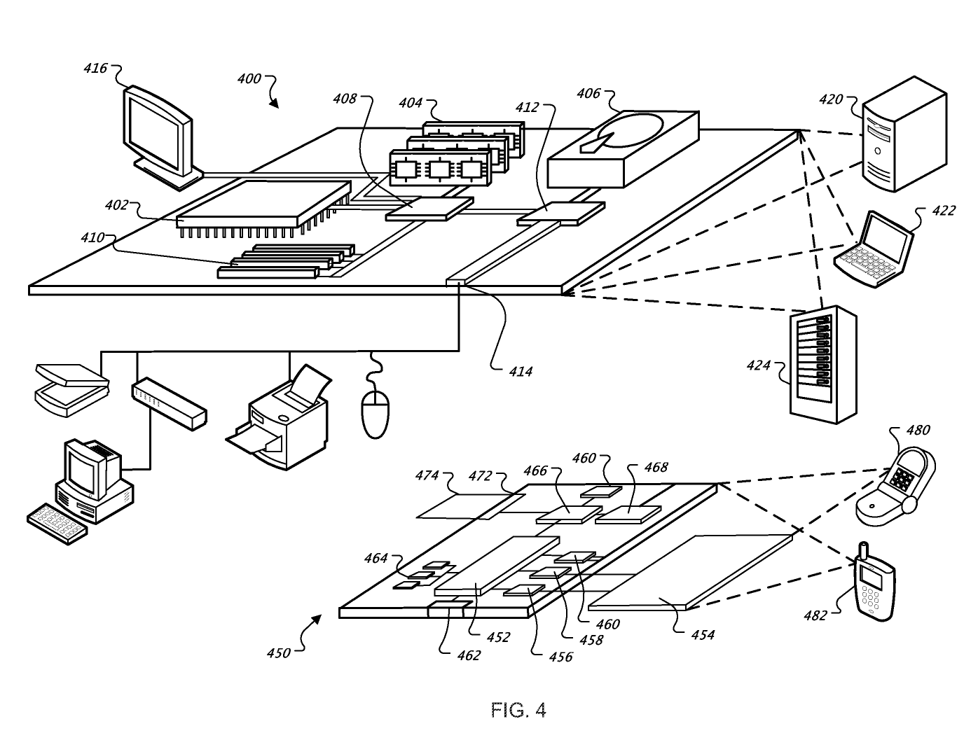

FIG. 4 is a block diagram of computing devices 400, 450 that may be used to implement the systems and methods described in this document, as either a client or as a server or plurality of servers. Computing device 400 is intended to represent various forms of digital computers, such as laptops, desktops, workstations, personal digital assistants, servers, blade servers, mainframes, and other appropriate computers. Computing device 450 is intended to represent various forms of mobile devices, such as personal digital assistants, cellular telephones, smartphones, and other similar computing devices. The components shown here, their connections and relationships, and their functions, are meant to be illustrative only, and are not meant to limit implementations of the inventions described and/or claimed in this document.

Computing device 400 includes a processor 402, memory 404, a storage device 406, a high-speed interface 408 connecting to memory 404 and high-speed expansion ports 410, and a low speed interface 412 connecting to low speed bus 414 and storage device 406. Each of the components 402, 404, 406, 408, 410, and 412, are interconnected using various busses, and may be mounted on a common motherboard or in other manners as appropriate. The processor 402 can process instructions for execution within the computing device 400, including instructions stored in the memory 404 or on the storage device 406 to display graphical information for a GUI on an external input/output device, such as display 416 coupled to high speed interface 408. In other implementations, multiple processors and/or multiple buses may be used, as appropriate, along with multiple memories and types of memory. Also, multiple computing devices 400 may be connected, with each device providing portions of the necessary operations (e.g., as a server bank, a group of blade servers, or a multi-processor system).

The memory 404 stores information within the computing device 400. In one implementation, the memory 404 is a computer-readable medium. The computer-readable medium is not a propagating signal. In one implementation, the memory 404 is a volatile memory unit or units. In another implementation, the memory 404 is a non-volatile memory unit or units.

The storage device 406 is capable of providing mass storage for the computing device 400. In one implementation, the storage device 406 is a computer-readable medium. In various different implementations, the storage device 406 may be a floppy disk device, a hard disk device, an optical disk device, or a tape device, a flash memory or other similar solid state memory device, or an array of devices, including devices in a storage area network or other configurations. In one implementation, a computer program product is tangibly embodied in an information carrier. The computer program product contains instructions that, when executed, perform one or more methods, such as those described above. The information carrier is a computer- or machine-readable medium, such as the memory 404, the storage device 406, or memory on processor 402.

The high speed controller 408 manages bandwidth-intensive operations for the computing device 400, while the low speed controller 412 manages lower bandwidth-intensive operations. Such allocation of duties is illustrative only. In one implementation, the high-speed controller 408 is coupled to memory 404, display 416 (e.g., through a graphics processor or accelerator), and to high-speed expansion ports 410, which may accept various expansion cards (not shown). In the implementation, low-speed controller 412 is coupled to storage device 406 and low-speed expansion port 414. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 400 may be implemented in a number of different forms, as shown in the figure. For example, it may be implemented as a standard server 420, or multiple times in a group of such servers. It may also be implemented as part of a rack server system 424. In addition, it may be implemented in a personal computer such as a laptop computer 422. Alternatively, components from computing device 400 may be combined with other components in a mobile device (not shown), such as device 450. Each of such devices may contain one or more of computing device 400, 450, and an entire system may be made up of multiple computing devices 400, 450 communicating with each other.

Computing device 450 includes a processor 452, memory 464, an input/output device such as a display 454, a communication interface 466, and a transceiver 468, among other components. The device 450 may also be provided with a storage device, such as a microdrive or other device, to provide additional storage. Each of the components 450, 452, 464, 454, 466, and 468, are interconnected using various buses, and several of the components may be mounted on a common motherboard or in other manners as appropriate.

The processor 452 can process instructions for execution within the computing device 450, including instructions stored in the memory 464. The processor may also include separate analog and digital processors. The processor may provide, for example, for coordination of the other components of the device 450, such as control of user interfaces, applications run by device 450, and wireless communication by device 450.

Processor 452 may communicate with a user through control interface 458 and display interface 456 coupled to a display 454. The display 454 may be, for example, a TFT LCD display or an OLED display, or other appropriate display technology. The display interface 456 may comprise appropriate circuitry for driving the display 454 to present graphical and other information to a user. The control interface 458 may receive commands from a user and convert them for submission to the processor 452. In addition, an external interface 462 may be provide in communication with processor 452, so as to enable near area communication of device 450 with other devices. External interface 462 may provide, for example, for wired communication (e.g., via a docking procedure) or for wireless communication (e.g., via Bluetooth or other such technologies).

The memory 464 stores information within the computing device 450. In one implementation, the memory 464 is a computer-readable medium. In one implementation, the memory 464 is a volatile memory unit or units. In another implementation, the memory 464 is a non-volatile memory unit or units. Expansion memory 474 may also be provided and connected to device 450 through expansion interface 472, which may include, for example, a SIMM card interface. Such expansion memory 474 may provide extra storage space for device 450, or may also store applications or other information for device 450. Specifically, expansion memory 474 may include instructions to carry out or supplement the processes described above, and may include secure information also. Thus, for example, expansion memory 474 may be provide as a security module for device 450, and may be programmed with instructions that permit secure use of device 450. In addition, secure applications may be provided via the SIMM cards, along with additional information, such as placing identifying information on the SIMM card in a non-hackable manner.

The memory may include for example, flash memory and/or MRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 464, expansion memory 474, or memory on processor 452.

Device 450 may communicate wirelessly through communication interface 466, which may include digital signal processing circuitry where necessary. Communication interface 466 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 468. In addition, short-range communication may occur, such as using a Bluetooth, WiFi, or other such transceiver (not shown). In addition, GPS receiver module 470 may provide additional wireless data to device 450, which may be used as appropriate by applications running on device 450.

Device 450 may also communication audibly using audio codec 460, which may receive spoken information from a user and convert it to usable digital information. Audio codex 460 may likewise generate audible sound for a user, such as through a speaker, e.g., in a handset of device 450. Such sound may include sound from voice telephone calls, may include recorded sound (e.g., voice messages, music files, etc.) and may also include sound generated by applications operating on device 450.

The computing device 450 may be implemented in a number of different forms, as shown in the figure. For example, it may be implemented as a cellular telephone 480. It may also be implemented as part of a smartphone 482, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back-end component (e.g., as a data server), or that includes a middleware component (e.g., an application server), or that includes a front-end component (e.g., a client computer having a graphical user interface or a Web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. For example, various forms of the flows shown above may be used, with steps re-ordered, added, or removed. Also, although several applications of the payment systems and methods have been described, it should be recognized that numerous other applications are contemplated. Accordingly, other embodiments are within the scope of the following claims.

What is claimed is:

1. A computer-implemented method comprising:
receiving data indicative of a landing page and data indicative of one or more types of business;
identifying one or more collections in a plurality of collections, the identified collections being based at least in part on the types of business and including one or more entities;
selecting a first group of one or more entities from the one or more identified collections;
identifying, from the landing page, a second group of one or more entities;
comparing the first group of entities with the second group of entities; and
generating, based on the comparing, selection criteria for one or more content items, wherein the selection criteria is used to identify one or more particular content items in response to receiving a request for information.

2. The computer-implemented method of claim 1, wherein receiving further comprises:
receiving data indicative of a business name,
wherein the data indicative of a landing page, the data indicative of one or more types of business, and the data indicative of the business name are received from a content sponsor.

3. The computer-implemented method of claim 1, wherein identifying one or more collections further comprises:
determining, based on the type of business, a quality score for one or more collections in the plurality of collections; and
selecting, as the identified collections, one or more collections in the plurality of collections that have a higher quality score relative to other collections in the plurality of collections.

4. The computer-implemented method of claim 3, wherein determining the quality score further comprises:
accessing a mapping between a type of business and a collection for which a quality score is predetermined; and
using the predetermined quality score as the determined quality score for a particular collection based on the accessing.

5. The computer-implemented method of claim 1, wherein selecting the first group of one or more entities from one or more identified collections further comprises:
performing at least one of a union operation and an intersection operation on the one or more identified collections; and
selecting the first group of one or more entities based on the performing.

6. The computer-implemented method of claim 1, wherein identifying, from the landing page, the second group of one or more entities further comprises:
identifying one or more entities from the landing page, the one or more identified entities being associated with a confidence score and an associated topicality score; and
selecting, as the second group of one or more entities, at least one or more of the one or more identified entities based on respective confidence score and topicality score.

7. The computer-implemented method of claim 1, wherein comparing the first group of entities with the second group of entities includes:
performing an intersection operation on the first collection and the second collection to determine one or more entities that are included in both the first collection and the second collection; and
wherein generating selection criteria includes generating selection criteria based at least in part on the intersection.

8. The computer-implemented method of claim 7, wherein generating the selection criteria comprises:
generating a campaign that, based on the comparing, includes selection criteria including one or more entities that are included in both the first collection and the second collection; and
associating the campaign with the one or more content items.

9. A computer program product embodied in a non-transitive computer-readable medium including instructions, that when executed, cause one or more processors to:
receive data indicative of a landing page and data indicative of one or more types of business;
identify one or more collections in a plurality of collections, the identified collections being based at least in part on the types of business and including one or more entities;
select a first group of one or more entities from the one or more identified collections;
identify, from the landing page, a second group of one or more entities;
compare the first group of entities with the second group of entities; and
generate, based on the comparing, selection criteria for one or more content items,
wherein the selection criteria is used to identify one or more particular content items in response to receiving a request for information.

10. The computer program product of claim 9, wherein receiving further comprises:
receiving data indicative of a business name,
wherein the data indicative of a landing page, the data indicative of one or more types of business, and the data indicative of the business name are received from a content sponsor.

11. The computer program product of claim 9, wherein identifying one or more collections further comprises:
determining, based on the type of business, a quality score for one or more collections in the plurality of collections; and
selecting, as the identified collections, one or more collections in the plurality of collections that have a higher quality score relative to other collections in the plurality of collections.

12. The computer program product of claim 11, wherein determining the quality score further comprises:
accessing a mapping between a type of business and a collection for which a quality score is predetermined; and
using the predetermined quality score as the determined quality score for a particular collection based on the accessing.

13. The computer program product of claim 9, wherein selecting the first group of one or more entities from the one or more identified collections further comprises:
performing at least one of a union operation and an intersection operation on the one or more identified collections; and
selecting the first group of one or more entities based on the performing.

14. The computer program product of claim 9, wherein identifying, from the landing page, the second group of one or more entities further comprises:
identifying one or more entities from the landing page, the one or more identified entities being associated with a confidence score and an associated topicality score; and
selecting, as the second group of one or more entities, at least one or more of the one or more identified entities based on respective confidence score and topicality score.

15. The computer program product of claim 9, wherein comparing the first group of entities with the second group of entities includes:
performing an intersection operation on the first collection and the second collection to determine one or more entities that are included in both the first collection and the second collection; and
wherein generating selection criteria includes generating selection criteria based at least in part on the intersection.

16. The computer program product of claim 15, wherein generating the selection criteria comprises:
generating a campaign that, based on the comparing, includes selection criteria including one or more entities that are included in both the first collection and the second collection; and
associating the campaign with the one or more content items.

17. A system comprising:
a collection identifier for identifying one or more collections that may include one or more relevant entities;
an annotator for parsing and extracting terms from text documents;
an entity selection engine for selecting one or more entities that are included in the one or more identified collections; and
an entity comparison engine for comparing entities in a first group of entities and other groups of entities.

18. The system of claim 17, wherein identifying one or more collections further comprises:
determining, based on the type of business, a quality score for one or more collections in the plurality of collections; and
selecting, as the identified collections, one or more collections in the plurality of collections that have a higher quality score relative to other collections in the plurality of collections.

19. The system of claim 18, wherein determining the quality score further comprises:
accessing a mapping between a type of business and a collection for which a quality score is predetermined; and
using the predetermined quality score as the determined quality score for a particular collection based on the accessing.

20. The system of claim 17, wherein comparing the first group of entities with the second group of entities includes:
performing an intersection operation on the first collection and the second collection to determine one or more entities that are included in both the first collection and the second collection; and
wherein generating selection criteria includes generating selection criteria based at least in part on the intersection.
